(19) United States
(12) Patent Application Publication
(10) Pub. No.: US 2026/0048785 A1
(43) Pub. Date: Feb. 19, 2026

(54) OVER-ACTUATED VEHICLE STEERING CONTROL SYSTEM TO COMPENSATE FOR INSTABILITY

(71) Applicant: TOYOTA RESEARCH INSTITUTE, INC., LOS ALTOS, CA (US)

(72) Inventors: ANDREA MICHELLE RIOS LAZCANO, Brussels (BE); HIROSHI YASUDA, San Carlos, CA (US)

(73) Assignees: TOYOTA RESEARCH INSTITUTE, INC., LOS ALTOS, CA (US); TOYOTA JIDOSHA KABUSHIKI KAISHA, TOYOTA-SHI (JP)

(21) Appl. No.: 18/803,122

(22) Filed: Aug. 13, 2024

(51) Int. Cl. B62D 6/00; B60W 30/02; B60W 60/00

(52) U.S. Cl. CPC B62D 6/00; B60W 30/02; B60W 60/0015; B60W 2520/14; B60W 2520/16; B60W 2520/18; B60W 2520/26; B60W 2710/202; B60W 2710/207

(57) ABSTRACT

Systems and methods actuate torque vectoring and independent wheel steering control capabilities of an over-actuated vehicle in order to compensate for instability in potentially dangerous driving scenarios, such as during towing of the over-actuated vehicle. The disclosed vehicle stabilization system can detect a condition associated with a movement of the over-actuated vehicle and dynamically generate a stabilization control command. A condition detected by the vehicle stabilization system can indicate instability of the over-actuated vehicle and include unstable conditions such as sway, jackknifing, oversteering, understeering, yaw instability, roll instability, and pitch instability. The stabilization control command indicates one or more independent wheel steering and torque vectoring controls for the over-actuated vehicle. The vehicle stabilization system can execute autonomous actions to maneuver the over-actuated vehicle based on the stabilization control command in a manner that compensate for the instability of the movement of the over-actuated vehicle.

### TECHNICAL FIELD

The present disclosure relates generally to systems and methods for controlling the steering of an over-actuated vehicle. More specifically, systems and methods are disclosed that utilize torque vectoring and independent wheel steering to compensate for instability experienced in an over-actuated vehicle, for example during towing of the vehicle.

### DESCRIPTION OF RELATED ART

An over-actuated vehicle refers to a vehicle that is equipped with more control inputs (e.g., steering, throttle, and braking) than typically necessary for basic operation. Accordingly, because an over-actuated vehicle has more control inputs, the over-actuated vehicle has more flexibility than many traditional vehicles. For example, an over-actuated vehicle can have tires with independent steering capabilities. The extra control that is supported by over-actuated vehicles allows for more precise handling and performance and can often be found in advanced autonomous vehicles or experimental prototypes. It may be advantageous to implement systems and techniques which leverage the enhanced capabilities of over-actuated vehicles in order to compensate for maneuvering instability in a range of scenarios that may be encountered with a moving vehicle, such as vehicle being towed.

### BRIEF SUMMARY OF THE DISCLOSURE

In accordance with one embodiment, a system may comprise a processor device that detects a condition associated with movement of an over-actuated vehicle. The processor device is configured to dynamically generate a stabilization control command in response to the detected condition. The stabilization control command indicates one or more independent wheel steering and torque vectoring controls for the over-actuated vehicle. The system further includes a controller device that executes autonomous actions to maneuver the over-actuated vehicle based on the stabilization control command.

In accordance with embodiments of the disclosed technology, a non-transitory computer readable medium may comprise instructions that implement that detecting a condition associated with movement of an over-actuated vehicle. The non-transitory computer readable medium may comprise further instructions that implement dynamically generating a stabilization control command in response to the detected condition; and executing autonomous actions to maneuver the over-actuated vehicle based on the stabilization control command. The stabilization control command indicates one or more independent wheel steering and torque vectoring controls for the over-actuated vehicle.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic illustrating a towing vehicle coupled to an over-actuated vehicle, and including an example of a vehicle stabilization system actuating independent wheel steering and torque vectoring of the over-actuated vehicle to compensate for unstable conditions, according to one or more embodiments shown and described herein.

FIG. 2 depicts an example network architecture of an in-vehicle vehicle stabilization system, in accordance with an embodiment of the technology disclosed herein.

FIG. 3 is a schematic representation of an example vehicle with which embodiments of the vehicle stabilization system disclosed herein may be implemented.

FIG. 4 illustrates an example computing component that may be used in implementing various features of embodiments of the disclosed technology.

The figures are not exhaustive and do not limit the present disclosure to the precise form disclosed.

### DETAILED DESCRIPTION

An over-actuated vehicle operates by utilizing its surplus of control inputs to optimize various aspects of performance, such as stability, maneuverability, and energy efficiency. These inputs allow the vehicle to adjust its behavior dynamically in response to changing conditions, improving its overall performance and safety. However, there are some driving scenarios, such as towing a heavy vehicle, which can result in driving conditions that are more dangerous than normal. For example, towing a vehicle can cause the towed vehicle to experience increased instability, understeering and/or jackknifing when driving, especially while cornering at higher speeds. This instability experienced during towing may be exacerbated when the towed vehicle has increased weight or is particularly large, such as in the case of large sports utility vehicles (SUVs). With a towed vehicle being more prone to sway instability, it can lead to further dangers, such as becoming unhinged from the tow, or being steered in an unsafe manner that may potentially result in collisions with other vehicles, objects, and/or pedestrians. As such, the disclosed embodiments include a vehicle stability system that actuates the torque vectoring and independent wheel steering control capabilities of an over-actuated vehicle in order to compensate for instability in these potentially dangerous driving scenarios, such as during the towing of a vehicle.

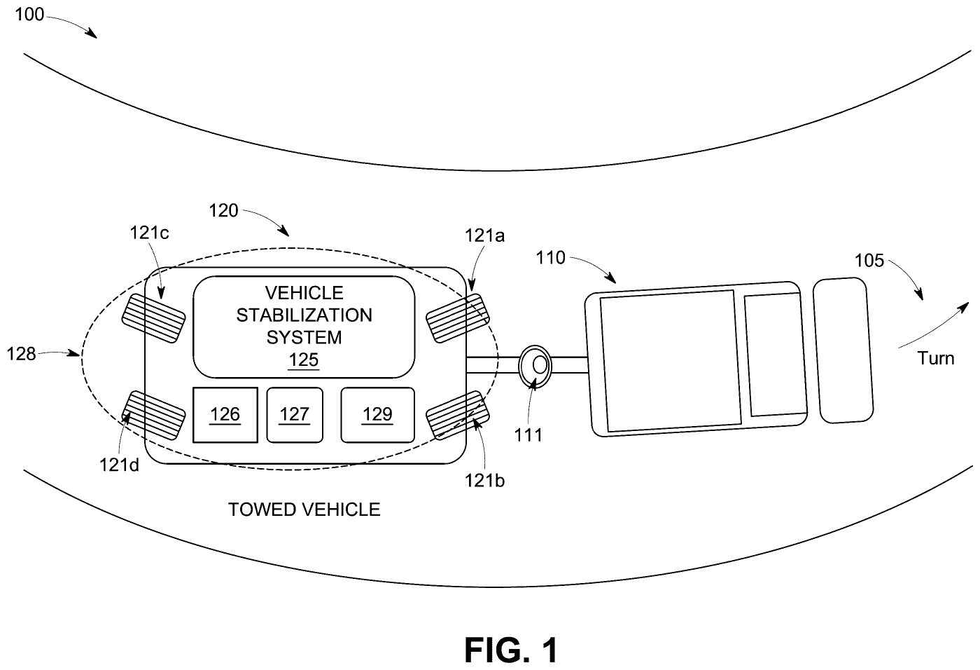

Referring now to FIG. 1, an example of a road environment 100 is depicted, which includes a vehicle 120, hereinafter referred to as a towed vehicle, which is hitched, or otherwise coupled, to the vehicle 110, referred to as a towing vehicle. As seen in FIG. 1, the towed vehicle 120 can include a vehicle controller 127, which enables various functions and/or controls other components of the towed vehicle 120. In particular, vehicle controller 127 can be configured to perform various computer-controlled operational modes, such as safety features (e.g., collision avoidance), autonomous driving operations, and semiautonomous driving operations. In some embodiments, the vehicle controller 127 is configured to be communicatively coupled with a disclosed vehicle stabilizer system 125 in order to support its functions, as described herein. Additionally, in the example of FIG. 1, the towed vehicle 120 is configured to implement the vehicle stabilization system 125 which monitors for unstable maneuvering conditions in movement (e.g., during towing), and utilizes independent wheel steering and torque vectoring capabilities to provide enhanced stabilization for the towed vehicle 120, as disclosed herein. Furthermore, the towed vehicle 120 is depicted as including a steer-by-wire system 128 (represented in FIG. 1 by dashed oval) which enables various capabilities that allows the towed vehicle 120 to operate as an over-actuated vehicle, for instance having individual wheel steering, which will be described in greater detail herein. It should be appreciated that the configuration illustrated in FIG. 1 is not intended to be limiting, and various other configurations for implementing vehicle stabilization of an over-actuated vehicle can be utilized without departing from the functions and structures, as disclosed herein. In an embodiment, the towing vehicle 120 can implement the vehicle stabilization system 125 including all of the functions and capabilities of the system 125 that are described in greater detail below.

Particularly, FIG. 1 illustrates an example of a road environment 100 that includes a section of a road 105 with a high curvature, such as an off-ramp or highway overpass. In FIG. 1, the towed vehicle 120 is implemented as an over-actuated vehicle that is designed with multiple independent actuators, for instance on each of its wheels 121a - 121c, for enhanced control and maneuverability. As seen, the towed vehicle 120 is hitched to the rear of the towing vehicle 110 for towing along this extremely curved section of the road 105. In this scenario, as the towing vehicle 110 travels along a highway overpass, for instance, it must navigate the tight curves in the road 105 with precision, ensuring the safety and stability of both vehicles 110 and 120.

The hitching mechanism 111 is used to securely connect the towed over-actuated vehicle 120 to the towing vehicle 110, allowing for a stable and controlled tow. As the towing vehicle 110 maneuvers along the highway overpass, it approaches the sharp bend in the illustrated section of the road 105. During towing, the towing vehicle 110 must ensure that both vehicles 110 and 120 navigate the complex road geometry safely, with the towing vehicle's 110 power and control effectively guiding the towed over-actuated vehicle 120 in a passive manner through the intricate turns of the road 105. The towing vehicle 110 must account for the added mass and potential sway of the towed vehicle 120 during towing, particularly in challenging road conditions such as curved road 105. However, in an instance where a driver of the towing vehicle 110 is not maneuvering in a safe manner, such as not maintaining a consistent speed and steering input around the tight curve in the road 105, there may be a potential of maneuvering instability of the towed vehicle 120 that is trailing the towing vehicle 110. Such maneuvering instability can prevent the towed vehicle 120 from following the towing vehicle 110 smoothly and may create dangerous conditions such as swaying, jackknifing, under/over steering, and undue stress on the hitch 111.

As described herein, the vehicle stabilization system 125 is designed to support enhanced stability for the towed vehicle 120 while its movement is being led by the towing vehicle 110. For example, the vehicle stabilization system 125 can individually adjust the actuation of each of the wheels 121a-121c of the towed vehicle 120 in order to maintain a safe driving trajectory through the curved section of the road 105.

The steer-by-wire system 128 of vehicle 120 can comprise a steering wheel which receives input from a driver to steer the vehicle 120 and having an actuator for movement; a steering rack also having actuator for movement; multiple wheel steering actuators (not shown) for movement, where each of the wheels 121a-121d of the towed vehicle 120 has at least one steering actuator configured thereon; and a steer-by-wire controller 129 that interacts with the vehicle stabilization system 125 and implements the various software and electro-mechanical functions that control the steering capabilities for the system 128 for the towed vehicle 120. In some embodiments, one or more of the various elements of the steer-by-wire system 128 are configured to be communicatively coupled with the disclosed vehicle stabilization system 125 to support the functions as described herein. As a general description, the steer-by-wire system 128 enables both manual driving (e.g., maneuvering and/or steering controller by the driver) and autonomous driving (e.g., computer-controlled maneuvering and/or steering) with electronic controls, by using electrically controlled motors (referring to herein as actuators) to change the direction of the wheels 121a-121d and to provide feedback to the driver. By utilizing the steer-by-wire system 128, the towed vehicle 120 has an electronic (or “by-wire”) connection between the steering wheel and the wheels 121a-121d (rather than a mechanical connection), thereby eliminating use of traditional mechanical components such as the intermediate shaft, steering column, and the like, which are used in conventional mechanical-based steering assemblies.

The steering wheel's 151 actuator generates the steering feel and passes the driver's steering signal “by-wire” quickly and precisely to the multiple actuators (actuators at the steering rack and wheels 121a-121d) which in turn, steers the wheels 121a-121d, depending on the driving speed and conditions and thereby enabling the towed vehicle 120 to operate as an over-actuated vehicle. The steer-by-wire system's 128 functions (e.g., controlling actuators, signals, steering) are controlled by the by controller 129, which implements the software and electro-mechanical elements designed to govern the sophisticated steering technology. The steer-by-wire system 128 can also enable a wide range of technical features for more safety, comfort and agility that were not possible with conventional steering systems. As alluded to above, the steer-by-wire system 128 implements independent wheel steering and torque vectoring capabilities of the towed over-actuated vehicle 120 that enables each of the wheels 121a-121d to be individually and/or independently steered (e.g., direction, and speed/torque). The steer-by-wire system 128 implements independent steering functions that allow each of the actuators of the towed vehicle's wheels 121a-121d to be steered (e.g., changing angular direction, etc.) independently and dynamically in a manner that offers significant advantages in terms of maneuverability, stability, and precision. Additionally, the steer-by-wire system 128 implements torque vectoring functions which enable the precise and dynamic distribution of torque individually to each of the actuators of the towed vehicle's wheels 121a-121d to optimize performance, handling, and stability. According to the embodiments, the steer-by-wire system 128 can receive stabilization control commands 126 from the vehicle stabilization system 125 in response to the detection of an unstable condition of the towed vehicle 120 while being led by the preceding towing vehicle 110. The vehicle stabilization system 125 can generate and output stabilization control commands (e.g., direction, and speed/torque) to the steer-by-wire system 128, which are instructions and/or signals that automatically effectuate independent wheel steering signals that trigger the actuators to adjust the torque and steering of one or more of the wheels 121a-121d in a precise manner to counteract any detected instability of the towed vehicle 120. For example, the vehicle stabilization system 125 may determine that the towing vehicle 110 is approaching the tight curve of road 105 at a rate of speed that presents an unstable condition, and then calculates stabilizing maneuvers that are sent to the steer-by-wire system 128, which involve independently controlling the front wheels 121a, 121b of the towed vehicle 120 to be turned to a particular angle to the left at a first torque, and the rear wheels 121c, 121d of the towed vehicle 120 to be turned to another particular angle to the right at a second torque, in order to autonomously stabilize movement of the towed over-actuated vehicle 120 in a manner that prevents jackknifing. It should be appreciated that implementation in a vehicle utilizing steer-by-wire for steering control, as described herein, is not intended to be limiting. Accordingly, the disclosed center indicator control system and functions can be implemented in vehicles using other forms of steering control mechanisms and assemblies.

The vehicle stabilization system 125 can be implemented as a vehicle controller, computing hardware, software, firmware, or a combination thereof, which is programmed to: monitor various parameters in order to detect and/predict one or more unstable conditions (e.g., sway, jackknifing and over/understeering) that may be experienced with towing of the towed over-actuated towed vehicle 120; and in response to identifying the unstable condition, generate and communicate stabilization control commands 126 to dynamically adjust and autonomously control the each of the wheels 121a-121b of the towed over-actuated vehicle 120 individually to compensate for the unstable condition. The vehicle stabilization system 125 is configured to identify, or otherwise determine, unstable conditions that may be experience in the passive movement of the over-actuated towed vehicle 120 while it is being towed and maneuverable led by the towing vehicle 110. The vehicle stabilization system 125 is distinctly configured to analyze various factors/characteristics related to driving conditions, such as the road 105, the towing vehicle 120, and the towing vehicle 110 that can indicate instability in the movement of the towing vehicle. The vehicle stabilization system 125 may identify that the current and/or predicted movement of the towed vehicle 120 has reached a level of an unstable condition when there are any detected disruptions to the vehicle's balance, traction, and steering response that leads to instability in the motion of the towed vehicle 120. For example, the vehicle stabilization system 125 may identify that the current movement of the towed vehicle 120 is an unstable condition when the front wheels 121a-121b of the towed vehicle's 120 are losing grip in a manner that may potentially lead to the loss of control or predictable behavior of the vehicle 102, or other dangerous conditions (e.g., off road condition, collision, damage, injury, etc.). The one or more unstable conditions that can be identified by the vehicle stabilization system 125 include but are not limited to: sway; jackknifing; over/understeering; yaw instability; roll instability; pitch instability; and the like.

The vehicle stabilization system 125 can identify an unstable condition in the movement of the towed vehicle 120 by analyzing several factors/characteristics related to the movement of the towed vehicle 120 and towing vehicle 110, and using various processes and techniques, including: monitoring a hitching angle of the hitch 111 connecting the towed vehicle 120 and the towing vehicle 110; receiving and analyzing Global Positioning System (GPS), navigation, and other map data associated with an upcoming path of the towed vehicle 120 or towing vehicle 120; monitoring the traction/wheel slip one or more wheels 121a-121d of the towed vehicle 120; monitoring parameters (speed, acceleration, direction, lateral motion, angular motion, weight distribution, suspension, aerodynamics, driver inputs, etc.) related to the movement and maneuvering of the towed vehicle 120 and towing vehicle; monitoring parameters (speed, acceleration, direction, lateral motion, angular motion, weight distribution, suspension, aerodynamics, driver inputs, etc.) related to the movement and maneuvering of the towed vehicle 120 with respect to the towing vehicle 110; monitoring driving conditions related to the road (e.g., road geometry, incline, weather, surface conditions, obstacles, etc.) and the like. As an example, the vehicle stabilization system 125 can receive real-time data (e.g., from on-vehicle sensors) obtained from monitoring the lateral acceleration of the towed over-actuated vehicle 120 and monitoring the lateral acceleration of the towing vehicle 110, and then perform a comparison of the real-time data to determine how the vehicles 110, 120 are moving in relation to each other. In this example, if the vehicle stabilization system 125 detects that the lateral acceleration of the over-actuated towed vehicle 120 is increasing with respect to the lateral acceleration of the towing vehicle 110, the vehicle stabilization system 125 can deem the sensed difference in acceleration as an indication of instability. The vehicle stabilization system 125 can monitor other factors/characteristics that are related to the comparative movement of the towed vehicle 120 with respect to the movement of the towing vehicle 110 in order to detect an unstable condition, such as yaw rate, hitch articulation, and the like.

In response to identifying the unstable condition, the vehicle stabilization system 125 can generate stabilization control commands 126 which dynamcally adjust steering of the towed vehicle 120 in a manner that compensates for instability of the towed vehicles 120 movement during towing. The vehicle stabilization system 125 is configured to analyze the various characteristics of the unstable condition in order calculate specific operational parameters for the over-actuated capabilities of the towed vehicle 120, where the operation parameters include independent steering and torque vectoring parameters that control one or more of the wheels 121a-121d independently in a manner that is deemed sufficient for counteracting the instability and optimizing stabilized motion of the towed vehicle 120 throughout the towing. The vehicle stabilization system 125 is configured to calculate one or more specific operational parameters (e.g., steering angle, torque/speed) to particularly control the towed vehicle 120 to achieve a determined speed, yaw, roll, pitch, traction, etc. that that has been analyzed to counteract the identified unstable condition, such as sway or jackknifing and enhance stability in the towed vehicle's 120 motion.

The stabilization control commands 126 are instructions and/or signals that are generated by the vehicle stabilization system 125 which dictate the operational parameters (e.g., direction, and speed/torque) to the steer-by-wire system 128. Thus, the steer-by-wire system 128 can receive one or more stabilization control commands 126 from the vehicle stabilization system 125 and automatically effectuate independent wheel steering signals that trigger the actuators to adjust the torque and steering of one or more of the wheels 121a-121d in a precise manner, based on the operational parameters, to counteract any detected instability of the towed vehicle 120. According to an embodiment, the vehicle stabilization system 125 is configured to iteratively perform in real-time the process of monitoring for unstable conditions and dynamically generating multiple stabilization control commands 126 that leverage over-actuated capabilities of the vehicle 120 to compensate for instability in the towed vehicle's 120 motion for a period of the time where the towed vehicle 120 is attached to the hitch 111, which is presumed to be during towing of the towed vehicle 120 led by the towing vehicle 110.

In the example of FIG. 1, the vehicle stabilization system 125 may determine that the towing vehicle 110 is approaching the tight curve of road 105 at a high rate of speed where the front wheels 121a-121b of the towed vehicle 120 are losing grip on the surface of the road 105 before the rear wheels 121c-121d in the turn, in a manner that is identified as an unstable condition (e.g., understeering). As a result of the identified unstable condition, the vehicle stabilization system 125 then dynamically generates stabilization control commands 126 that indicate the operational parameters for autonomous stabilizing maneuvers, namely dynamically adjusting the steering for one or more of the wheels 121a-121d independently, where the stabilization control commands 126 can be executed to autonomously maneuver the over-actuated towed vehicle 120 and the operational parameters have been particularly calculated to compensate for the identified understeering (e.g., unstable condition) of vehicle 120. The stabilization control commands 126 are communicated to the steer-by-wire system 128, which involve independently controlling the front wheels 121a, 121b of the towed vehicle 120 to be turned to a particular angle to the left at a first torque, and the rear wheels 121c, 121d of the towed vehicle 120 to be turned to another particular angle to the right at a second torque, in order to autonomously maneuver the over-actuated towed vehicle 120 in a manner that stabilizes its movement and compensates for the identified unstable condition. In the example of FIG. 1, the over-actuated towed vehicle 120, under control of the vehicle stabilization system 125, can autonomously maneuver to reduce its speed and turn at a greater angle into the curve of the road 105 in order to counteract the detected understeering and ultimately mitigate dangerous outcomes of instability such as loss of control, accidents, and injury.

Although the example described with reference to FIG. 1 involves a type of autonomous vehicle, the systems and methods described herein can be implemented in other types of vehicles including semi-autonomous vehicles, vehicles with automatic controls (e.g., dynamic cruise control), or other vehicles. Also, the vehicle 120 implementing the vehicle stabilization system 125 and functions described herein can be a type of hybrid electric vehicle (HEV). However, this is not intended to be limiting, and the disclosed embodiments can be implemented in other types of vehicles including gasoline-or diesel-powered vehicles, fuel-cell vehicles, electric vehicles, or other vehicles.

According to an embodiment, vehicles implementing the vehicle stabilization system 125 can be a semi-autonomous vehicle, such as a vehicle having assisted driving capabilities, which also implements the vehicular knowledge networking and improved knowledge cycle functions, as disclosed herein. “Semi-autonomous operational mode” means that a portion of the navigation and/or maneuvering of the vehicle 120 along a travel route is performed by one or more computing systems, and a portion of the navigation and/or maneuvering of the vehicle 120 along a travel route is performed by a human driver. One example of a semi-autonomous operational mode is when an adaptive cruise control system is activated. In such case, the speed of the vehicle 120 can be automatically adjusted to maintain a safe distance from a vehicle ahead based on data received from on-board sensors, but the vehicle 120 is otherwise operated manually by a human driver. Upon receiving a driver input to alter the speed of the vehicle (e.g., by depressing the brake pedal to reduce the speed of the vehicle), the speed of the vehicle is reduced. Thus, with vehicle 120A operating as a semi-autonomous vehicle, a response can be partially automated. In an example, the controller communicates a newly generated (or updated) control to the vehicle 120 operating as a semi-autonomous vehicle. The vehicle 120 can automatically perform some of the desired adjustments (e.g., accelerating) with no human driver interaction. Alternatively, the vehicle 120 may notify a driver that driver input is necessary or desired in response to a new (or updated) safety control.

Alternatively, or in addition to the above-described modes, vehicle implementing the disclosed vehicle stabilization system 125 can have one or more autonomous operational modes. As used herein, “autonomous vehicle” means a vehicle that is configured to operate in an autonomous operational mode. “Autonomous operational mode” means that one or more computing systems of the vehicles 120 are used to navigate and/or maneuver the vehicle along a travel route with a limited level of input from a human driver which varies with the operational mode. As such, vehicle 120 can have a plurality of autonomous operational modes, where each mode correspondingly responds to a controller, with a varied level of automated response. In some embodiments, the vehicle 120 can have an unmonitored autonomous operational mode. “Unmonitored autonomous operational mode” means that one or more computing systems are used to maneuver the vehicle along a travel route fully autonomously, requiring no input or supervision required from a human driver. Thus, as an unmonitored autonomous vehicle, vehicle 120 responses can be highly, or fully, automated. For example, a controller can be configured to communicate controls generated by the vehicle stabilization system 125 so as to operate the vehicle autonomously and safely. After the controller communicates a control to the vehicle 120 operating as an autonomous vehicle, the vehicle 120 can automatically perform the desired adjustments (e.g., independent wheel steering, torque vectoring) with no human driver interaction. Accordingly, vehicles 120A can operate any of its components autonomously, such as an engine.

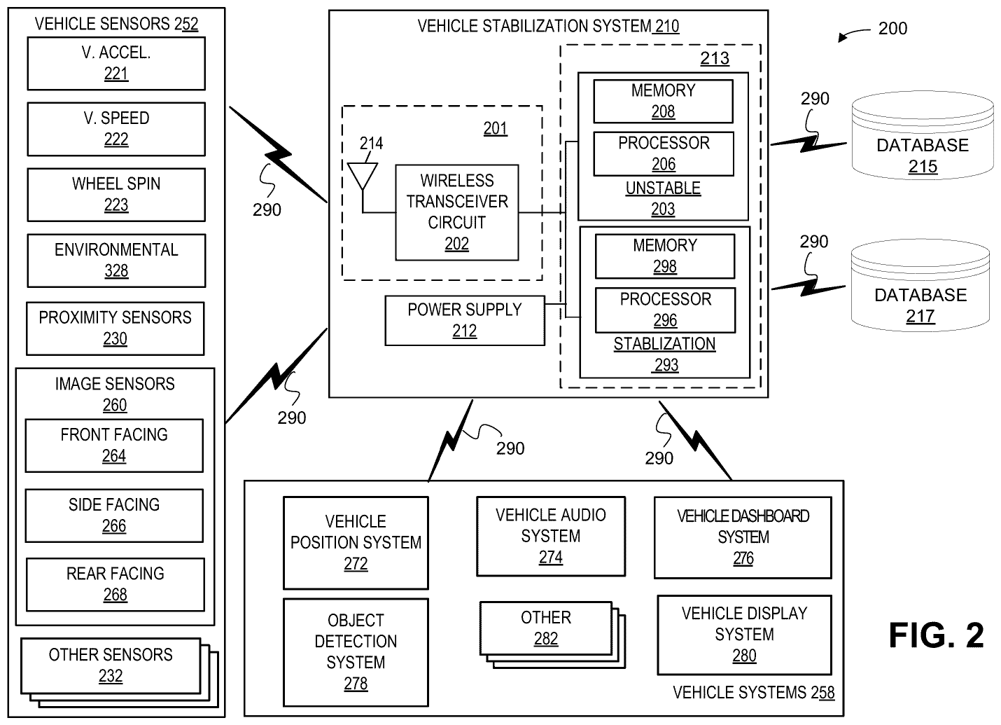

FIG. 2 depicts an example network architecture of in-vehicle vehicle stabilization system in accordance with one embodiment of the systems and methods described herein. The vehicle 200 implementing a vehicle stabilization system includes a vehicle stabilization system circuit 210 communicatively connected to a plurality of sensors 252, a plurality of vehicle systems 258, a database 215 comprising roadway data, and a database 217. Sensors 252 and vehicle systems 258 wirelessly communicate with the vehicle stabilization system circuit 210. Although in this example sensors 252 and vehicle systems 258 are depicted as communicating with vehicle stabilization system circuit 210, they can also communicate with each other as well as with other vehicle systems. The vehicle stabilization system circuit 210 can be implemented as an ECU or as part of an ECU. In other embodiments, the vehicle stabilization system circuit 210 can be implemented independently of the ECU.

The vehicle stabilization system circuit 210 in this example includes a communication circuit 201, a controller/CPU 313 comprising an unstable condition engine 203, and a stabilization control command engine 293, and a power supply 212. Each engine includes a respective processor 206, 296 and respective memory 208, 296. For example, the unstable condition engine 203 includes a processor 206, and a memory 208 configured for performing the functions associated with detecting an unstable condition of a towed over-actuated vehicle described herein, and the stabilization control command engine 293 includes a processor 296 and a memory 298 configured for performing functions associated with generating independent wheel steering and torque vectoring controls for an over-actuated towed vehicle in order to compensate for instability, as described herein.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store instructions and variables for processor 206 as well as any other suitable information, such as, one or more of the following elements: rules data; resource data; GPS data; and base data, as described below. Memory 208 can be made up of one or more modules of one or more different types of memory, and may be configured to store data and other information as well as operational instructions that may be used by the processors 206 and 296.

Although the example of FIG. 2 is illustrated using processor and memory circuitry, as described below with reference to circuits disclosed herein, controller/CPU 213 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up the vehicle stabilization system circuit 210. Communication circuit 201 includes either or both a wireless transceiver circuit 202 with an associated antenna 214 and a wired I/O interface with an associated hardwired data port (not illustrated). Communication circuit 201 can provide for V2X communications capabilities, allowing the mitigative action selection circuit 210 to communicate with edge devices, such as roadside equipment (RSE), network cloud servers and cloud-based databases, and/or other vehicles.

As this example illustrates, communications with the vehicle stabilization system circuit 210 can include either or both wired and wireless communications circuits 201. Wireless transceiver circuit 202 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by the vehicle stabilization system circuit 210 to/from other entities such as sensors 252 and vehicle systems 258.

Power supply 212 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

In the illustrated example, sensors 252 include vehicle acceleration sensors 321, vehicle speed sensors 222, wheelspin sensors 223 (e.g., one for each wheel), environmental sensors 228 (e.g., to detect salinity or other environmental conditions), proximity sensor 230 (e.g., sonar, radar, lidar or other vehicle proximity sensors), and image sensors 260. Additional sensors (i.e., other sensors 232) can be included as may be appropriate for a given implementation of the vehicle stabilization system for the vehicle 200.

The sensors 252 include front facing image sensors 264, side facing image sensors 266, and/or rear facing image sensors 268. Image sensors may capture information which may be used in detecting not only vehicle conditions but also detecting conditions external to the vehicle 120 (shown in FIG. 1) as well. Image sensors that might be used to detect external conditions can include, for example, cameras or other image sensors configured to capture data in the form of sequential image frames forming a video in the visible spectrum, near infra-red (IR) spectrum, IR spectrum, ultraviolet spectrum, etc. Image sensors 260 can be used to, for example, to detect objects in an environment surrounding the vehicle 120, for example, traffic signs indicating a current speed limit, road curvature, obstacles, surrounding vehicles, and so on. For example, one or more image sensors 260 may capture images of neighboring vehicles in the surrounding environment. As another example, object detecting and recognition techniques may be used to detect objects and environmental conditions, such as, but not limited to, road conditions, surrounding vehicle behavior (e.g., driving behavior and the like), parking availability, etc. Additionally, sensors may estimate proximity between vehicles. For instance, the image sensors 260 may include cameras that may be used with and/or integrated with other proximity sensors 230 such as LIDAR sensors or any other sensors capable of capturing a distance. As used herein, a sensor set of a vehicle may refer to sensors 252 and image sensors 260 as a set.

Vehicle systems 258 include any of a number of different vehicle components or subsystems used to control or monitor various aspects of the vehicle and its performance. In this example, the vehicle systems 258 includes a vehicle positioning system 272; vehicle audio system 274 comprising one or more speakers configured to deliver audio throughout the vehicle; object detection system 278 to perform image processing such as object recognition and detection on images from image sensors 260, proximity estimation, for example, from image sensors 260 and/or proximity sensors, etc. for use in other vehicle systems; suspension system 280 such as, for example, an adjustable-height air suspension system, or an adjustable-damping suspension system; and other vehicle systems 282 (e.g., (e.g., Advanced Driver-Assistance Systems (ADAS), such as forward/rear collision detection and warning systems, pedestrian detection systems, autonomous or semi-autonomous driving systems, and the like).

The vehicle positioning system 272 includes a global positioning system (GPS). The vehicle 120 may be DSRC-equipped vehicles. A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

A DSRC-compliant GPS unit is operable to provide positional information for a vehicle (or some other DSRC-equipped device that includes the DSRC-compliant GPS unit) that has lane-level accuracy. In some embodiments, a DSRC-compliant GPS unit is operable to identify, monitor and track its two-dimensional position within 1.5 meters of its actual position 68% of the time under an open sky.

Conventional GPS communication includes a GPS satellite in communication with a vehicle comprising a GPS tracking device. The GPS tracking device emits/receives a signal to/from the GPS satellite. For example, a GPS tracking device is installed into a vehicle. The GPS tracking device receives position data from the GPS tracking device. The position data gathered from the vehicle is stored in the tracking device. The position data is transmitted to the cloud server via a wireless network.

A conventional GPS provides positional information that describes a position of a vehicle with an accuracy of plus or minus 10 meters of the actual position of the conventional GPS unit. By comparison, a DSRC-compliant GPS unit provides GPS data that describes a position of the DSRC-compliant GPS unit with an accuracy of plus or minus 1.5 meters of the actual position of the DSRC-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in on a roadway. Some safety or autonomous driving applications provided by an Advanced Driver Assistance System (ADAS) of a modern vehicle require positioning information that describes the location of the vehicle with lane-level accuracy. In addition, the current standard for DSRC requires that the location of the vehicle be described with lane-level accuracy.

As used herein, the words “geographic location,” “location,” “geographic position” and “position” refer to a latitude and longitude of an object (or, a latitude, longitude, and elevation of an object), such as a connected vehicle, an RSE, a client device, etc. As used herein, the words “geographic area”, and “area,” refer to a physical space surrounding a location (e.g., an area of defined space surrounding a geographic location or geographic position). The example embodiments described herein may provide positioning information that describes a geographic position of a vehicle with an accuracy of one or more of: (1) at least plus or minus 1.5 meters in relation to the actual geographic position of the vehicle in two dimensions including a latitude and a longitude; and (2) at least plus or minus 3 meters in relation to the actual geographic position of the vehicle in an elevation dimension. Accordingly, the example embodiments described herein are able to describe the geographic position of the vehicle with lane-level accuracy or better.

Network 290 may be a conventional type of network, wired or wireless, and may have numerous different configurations including a star configuration, token ring configuration, or other configurations. Furthermore, the network 290 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 290 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VoLTE, 5G-V2X or any other mobile data network or combination of mobile data networks. Further, the network 290 may include one or more IEEE 802.11 wireless networks.

In one embodiment, data comprising the location of vehicle is captured by the vehicle position system 258. The vehicle position system 258 can include one or more sensors 252configured to capture vehicle position data. The vehicle positioning system 272 communicates with the vehicle stabilization system circuit 210 to communicate and utilize stabilization commands at the vehicle 120 for various driving and/or maneuvering functions, including autonomous or semi-autonomous vehicle/driver safety features.

In an embodiment, the vehicle stabilization system circuit 210 produces notifications for the driver of the vehicle 200 using one or more notification methods. For example, the driver may receive a visual and/or audible notification that the vehicle may need to perform a maneuver to mitigate an unstable condition during towing, based on data that the vehicle stabilization system circuit 210 has analyzed accordance with the capabilities, as disclosed herein. In one embodiment, the notification methods include the vehicle systems 258 comprising the vehicle audio system 272 and the vehicle dashboard system 276. The notification methods includes visual and/or audible methods of informing the driver of safety related issues. In one embodiment, the notification methods include notifying the driver of the vehicle 200 of the unstable condition and/or a stabilization maneuver via one or more vehicle systems 258. For example, in one embodiment, the driver is notified of an unstable condition via the vehicle audio system 274 (e.g., instructions played/broadcasted over one or more vehicle speakers), the vehicle display system 280 and/or the vehicle dashboard system 276. In one embodiment, the driver is notified of safety issues by a navigation system within the instrument cluster and the dashboard GUI. The notification can include visual instructions (e.g., visual directions on how to proceed), and/or auditory instructions (e.g., verbal commands from the vehicle stabilization system circuit 210 to the driver).

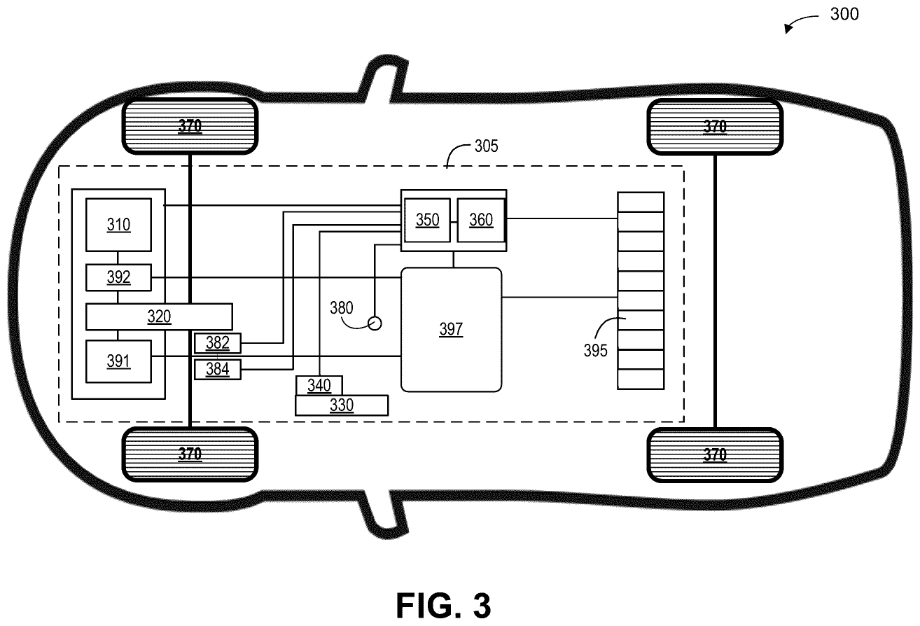

FIG. 3 illustrates an example hybrid electric vehicle (HEV) 300 in which various embodiments for the vehicle stabilization system are implemented. For example, in one embodiment, the vehicle 120 (shown in FIG. 1) is a HEV 300. It should be understood that various embodiments disclosed herein may be applicable to/used in various vehicles (internal combustion engine (ICE) vehicles, fully electric vehicles (EVs), etc.) that are fully or partially autonomously controlled/operated, and not solely HEVs.

Here, HEV 300 includes drive force unit 305 and wheels 370. Drive force unit 305 includes an engine 310, motor generators (MGs) 391 and 392, a battery 395, an inverter 397, a brake pedal 330, a brake pedal sensor 340, a transmission 320, a memory 360, an electronic control unit (ECU) 350, a shifter 380, a speed sensor 382, and an accelerometer 384.

Engine 310 primarily drives the wheels 370. Engine 310 can be an ICE that combusts fuel, such as gasoline, ethanol, diesel, biofuel, or other types of fuels which are suitable for combustion. The torque output by engine 410 is received by the transmission 320. MGs 391 and 392 can also output torque to the transmission 320. Engine 310 and MGs 391 and 392 may be coupled through a planetary gear (not shown in FIG. 3). The transmission 320 delivers an applied torque to the wheels 370. The torque output by engine 310 does not directly translate into the applied torque to the wheels 370.

MGs 391 and 392 can serve as motors which output torque in a drive mode, and can serve as generators to recharge the battery 395 in a regeneration mode. The electric power delivered from or to MGs 391 and 392 passes through inverter 397 to battery 395. Brake pedal sensor 340 can detect pressure applied to brake pedal 330, which may further affect the applied torque to wheels 370. Speed sensor 382 is connected to an output shaft of transmission 320 to detect a speed input which is converted into a vehicle speed by ECU 350. Accelerometer 384 is connected to the body of HEV 300 to detect the actual deceleration of HEV 300, which corresponds to a deceleration torque.

Transmission 320 is a transmission suitable for an HEV. For example, transmission 320 can be an electronically controlled continuously variable transmission (ECVT), which is coupled to engine 310 as well as to MGs 391 and 392. Transmission 320 can deliver torque output from a combination of engine 310 and MGs 391 and 392. The ECU 350 controls the transmission 320, utilizing data stored in memory 360 to determine the applied torque delivered to the wheels 370. For example, ECU 350 may determine that at a certain vehicle speed, engine 310 should provide a fraction of the applied torque to the wheels while MG 391 provides most of the applied torque. ECU 350 and transmission 340 can control an engine speed (NE) of engine 340 independently of the vehicle speed (V).

ECU 340 may include circuitry to control the above aspects of vehicle operation. ECU 340 may include, for example, a microcomputer that includes a one or more processing units (e.g., microprocessors), memory storage (e.g., RAM, ROM, etc.), and I/O devices. ECU 340 may execute instructions stored in memory to control one or more electrical systems or subsystems in the vehicle. ECU 340 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS) or electronic stability control (ESC)), battery management systems, and so on. These various control units can be implemented using two or more separate electronic control units, or using a single electronic control unit.

MGs 341 and 342 each may be a permanent magnet type synchronous motor including for example, a rotor with a permanent magnet embedded therein. MGs 341 and 342 may each be driven by an inverter controlled by a control signal from ECU 340 so as to convert direct current (DC) power from battery 345 to alternating current (AC) power, and supply the AC power to MGs 341, 342. MG 342 may be driven by electric power generated by motor generator MG 341. It should be understood that in embodiments where MG 341 and MG 342 are DC motors, no inverter is required. The inverter, in conjunction with a converter assembly may also accept power from one or more of MGs 341, 342 (e.g., during engine charging), convert this power from AC back to DC, and use this power to charge battery 395 (hence the name, motor generator). ECU 350 may control the inverter, adjust driving current supplied to MG 392, and adjust the current received from MG 391 during regenerative coasting and braking.

Battery 395 may be implemented as one or more batteries or other power storage devices including, for example, lead-acid batteries, lithium ion, and nickel batteries, capacitive storage devices, and so on. Battery 395 may also be charged by one or more of MGs 391, 392, such as, for example, by regenerative braking or by coasting during which one or more of MGs 391, 392 operates as generator. Alternatively (or additionally, battery 395 can be charged by MG 391, for example, when HEV 300 is in idle (not moving/not in drive). Further still, battery 395 may be charged by a battery charger (not shown) that receives energy from engine 310. The battery charger may be switched or otherwise controlled to engage/disengage it with battery 395. For example, an alternator or generator may be coupled directly or indirectly to a drive shaft of engine 310 to generate an electrical current as a result of the operation of engine 310. Still other embodiments contemplate the use of one or more additional motor generators to power the rear wheels of a vehicle (e.g., in vehicles equipped with 4-Wheel Drive), or using two rear motor generators, each powering a rear wheel.

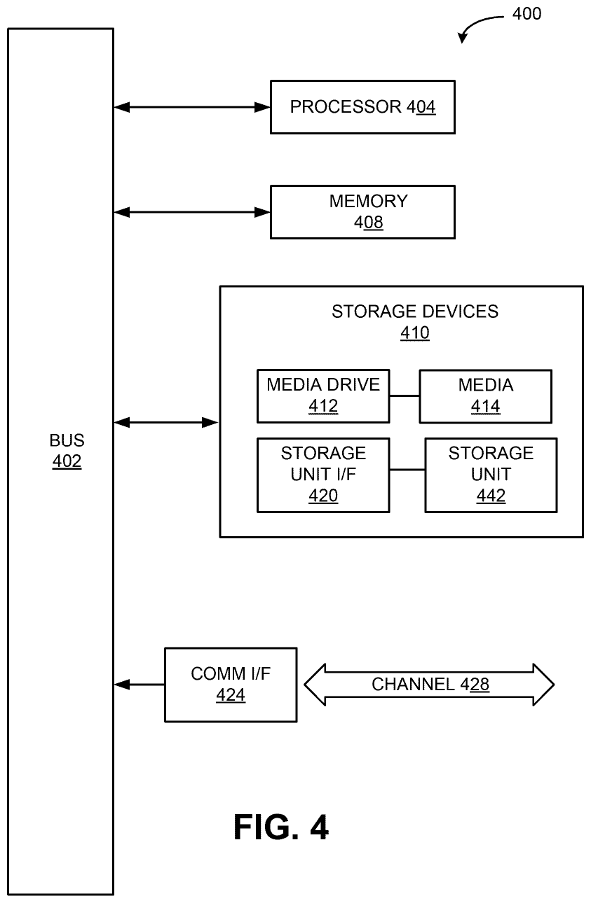

Battery 395 may also be used to power other electrical or electronic systems in the vehicle. Battery 395 can include, for example, one or more batteries, capacitive storage units, or other storage reservoirs suitable for storing electrical energy that can be used to power MG 391 and/or MG 392. When battery 395 is implemented using one or more batteries, the batteries can include, for example, nickel metal hydride batteries, lithium ion batteries, lead acid batteries, nickel cadmium batteries, lithium ion polymer batteries, and other types of batteries.

Where components are implemented in whole or in part using software, these software elements can be implemented to operate with a computing or processing component capable of carrying out the functionality described with respect thereto. One such example computing component is shown in FIG. 4. Various embodiments are described in terms of this example-computing component 400. After reading this description, it will become apparent to a person skilled in the relevant art how to implement the application using other computing components or architectures.

Referring now to FIG. 4, computing component 400 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 400 might also represent computing capabilities embedded within or otherwise available to a given device. For example, a computing component might be found in other electronic devices such as, for example, portable computing devices, and other electronic devices that might include some form of processing capability.

Computing component 400 might include, for example, one or more processors, controllers, control components, or other processing devices. This can include a processor 404. Processor 404 might be implemented using a general-purpose or special-purpose processing engine such as, for example, a microprocessor, controller, or other control logic. Processor 404 may be connected to a bus 402. However, any communication medium can be used to facilitate interaction with other components of computing component 400 or to communicate externally.

Computing component 400 might also include one or more memory components, simply referred to herein as main memory 408. For example, random access memory (RAM) or other dynamic memory, might be used for storing information and instructions to be executed by processor 404. Main memory 408 might also be used for storing temporary variables or other intermediate information during execution of instructions to be executed by processor 404. Computing component 400 might likewise include a read only memory (“ROM”) or other static storage device coupled to bus 402 for storing static information and instructions for processor 504.

The computing component 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a solid-state drive, a magnetic tape drive, an optical drive, a compact disc (CD) or digital video disc (DVD) drive (R or RW), or other removable or fixed media drive might be provided. Storage media 414 might include, for example, a hard disk, an integrated circuit assembly, magnetic tape, cartridge, optical disk, a CD or DVD. Storage media 414 may be any other fixed or removable medium that is read by, written to or accessed by media drive 412. As these examples illustrate, the storage media 514 can include a computer usable storage medium having stored therein computer software or data.

In alternative embodiments, information storage mechanism 410 might include other similar instrumentalities for allowing computer programs or other instructions or data to be loaded into computing component 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory component) and memory slot. Other examples may include a PCMCIA slot and card, and other fixed or removable storage units 422 and interfaces 420 that allow software and data to be transferred from storage unit 422 to computing component 400.

Computing component 400 might also include a communications interface 424. Communications interface 424 might be used to allow software and data to be transferred between computing component 400 and external devices. Examples of communications interface 424 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 424 may be carried on signals, which can be electronic, electromagnetic (which includes optical) or other signals capable of being exchanged by a given communications interface 424. These signals might be provided to communications interface 424 via a channel 428. Channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 408, storage unit 420, media 414, and channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 400 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known. ” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system, comprising:
a processor device detecting a condition associated with a movement of an over-actuated vehicle and dynamically generating a stabilization control command in response to the detected condition, wherein the stabilization control command indicates one or more independent wheel steering and torque vectoring controls for the over-actuated vehicle; and
a controller device executing autonomous actions to maneuver the over-actuated vehicle based on the stabilization control command.

2. The system of claim 1, wherein the processor device detects the movement of the over-actuated vehicle while a hitch connects the over-actuated vehicle to a towing vehicle.

3. The system of claim 2, wherein the processor device detects a condition by determining instability of the movement of the over-actuated vehicle while the hitch connects the over-actuated vehicle to the towing vehicle.

4. The system of claim 3, wherein the processor device monitors factors related to the movement of the over-actuated vehicle to detect the condition, and the detected condition comprises one or more of: sway, jackknifing, oversteering, understeering, yaw instability, roll instability, and pitch instability.

5. The system of claim 4, wherein monitoring factors related to the movement of the over-actuated vehicle comprises one or more of:
monitoring a hitching angle of the hitch connected to the over-actuated vehicle; receiving Global Positioning System (GPS) navigation data;
monitoring the traction or wheel slip of one or more wheels of the over-actuated vehicle; monitoring movement of the over-actuated vehicle in relation to the towing vehicle; and monitoring driving conditions related to a road.

6. The system of claim 4, wherein the over-actuated vehicle comprises a steer-by-wire system.

7. The system of claim 6, wherein the steer-by-wire system comprises one or more actuators for independent wheel steering and torque vectoring control of each wheel of the over-actuated vehicle.

8. The system of claim 7, wherein the steer-by-wire system receives the generated stabilization control command and automatically effectuates the one or more actuators to independently adjust the torque and steering direction of one or more of the wheels of the over-actuated vehicle in accordance with the independent wheel steering and torque vectoring control.

9. The system of claim 8, wherein executing the autonomous actions to maneuver the over-actuated vehicle are based on the independent adjustment of the torque and steering direction of the one or more of the wheels of the over-actuated vehicle.

10. The system of claim 3, wherein executing the autonomous actions to maneuver the over-actuated vehicle compensates for the instability of the movement of the over-actuated vehicle associated with the detected condition.

11. The system of claim 1, wherein the over-actuated vehicle comprises an autonomous vehicle.

12. A non-transitory computer readable medium comprising instructions, that when read by a processor, cause the processor to:
detect a condition associated with a movement of an over-actuated vehicle;
dynamically generate a stabilization control command in response to the detected condition, wherein the stabilization control command indicates one or more independent wheel steering and torque vectoring controls for the over-actuated vehicle; and
execute autonomous actions to maneuver the over-actuated vehicle based on the stabilization control command.

13. The non-transitory computer readable medium of claim 12, wherein the instructions, when read by a processor, further cause the processor to detect the movement of the over-actuated vehicle while a hitch connects the over-actuated vehicle to a towing vehicle.

14. The non-transitory computer readable medium of claim 13, wherein the instructions, when read by a processor, further cause the processor to detect the condition by determining instability of the movement of the over-actuated vehicle while the hitch connects the over-actuated vehicle to the towing vehicle.

15. The non-transitory computer readable medium of claim 14, wherein the instructions, when read by a processor, further cause the processor to monitor factors related to the movement of the over-actuated vehicle to detect the condition, and the detected condition comprises one or more of:
sway, jackknifing, oversteering, understeering, yaw instability, roll instability, and pitch instability.

16. The non-transitory computer readable medium of claim 15, wherein monitoring factors related to the movement of the over-actuated vehicle comprises one or more of: monitoring a hitching angle of the hitch connected to the over-actuated vehicle; receiving Global Positioning System (GPS) navigation data; monitoring the traction or wheel slip of one or more wheels of the over-actuated vehicle; monitoring movement of the over-actuated vehicle in relation to the towing vehicle; and monitoring driving conditions related to a road.

17. The non-transitory computer readable medium of claim 15, wherein the over-actuated vehicle comprises a steer-by-wire system.

18. The non-transitory computer readable medium of claim 17, wherein the steer-by-wire system comprises one or more actuators for independent wheel steering and torque vectoring control of each wheel of the over-actuated vehicle.

19. The non-transitory computer readable medium of claim 15, wherein the instructions, when read by a processor, further cause the processor to send the generated stabilization control command to the steer-by-wire system which automatically effectuates the one or more actuators to independently adjust the torque and steering direction of one or more of the wheels of the over-actuated vehicle in accordance with the independent wheel steering and torque vectoring control.

20. The non-transitory computer readable medium of claim 14, wherein the instructions, when read by a processor, further cause the processor to maneuver the over-actuated vehicle to compensate for the instability of the movement of the over-actuated vehicle associated with the detected condition.
